(19) United States
(12) Patent Application Publication
(10) Pub. No.: US 2008/0101841 A1
(43) Pub. Date: May 1, 2008

(54) Image Generating Apparatus

(75) Inventor: Atsushi MUSHIMOTO, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/854,603

(22) Filed: Sep. 13, 2007

(30) Foreign Application Priority Data
Oct. 25, 2006 (JP) 2006-289450

(51) Int. Cl. B41J 19/00

(52) U.S. Cl. 400/569

(57) ABSTRACT

This image generating apparatus is so formed that load torque in a direction for increasing the inner diameter of a coil portion is applied to a torque generation spring member of a take-up portion when an ink sheet is taken up while rotational motion of a gear portion is prevented from transmission to a take-up reel if load torque exceeding a prescribed level is applied to the take-up reel.

### BACKGROUND OF THE INVENTION

1. Field of the Invention

The present invention relates to an image generating apparatus.

2. Description of the Background Art

An image generating apparatus comprising a clutch mechanism provided on a rotational driving portion is known as a kind of conventional image generating apparatus, as disclosed in Japanese Patent Laying-Open No. 2004-92759, 2002-227877, 06-330962 (1994) or 05-157125 (1993), for example.

Each of the aforementioned Japanese Patent Laying-Open Nos. 2004-92759 and 2002-227877 discloses a one-way clutch or a clutch provided with a clutch spring having first and second sides attached to columnar portions of a base portion and a rotating portion respectively. When the rotating portion rotates by driving force received from a driving source in a first direction for increasing the inner diameter of the clutch spring, adhesion between the columnar portions and the clutch spring is reduced to idle the rotating portion. When the rotating portion rotates in a second direction for reducing the inner diameter of the clutch spring, on the other hand, the adhesion between the columnar portions and the clutch spring is increased to transmit the rotation of the rotating portion to the base portion. In other words, each of the aforementioned Japanese Patent Laying-Open Nos. 2004-92759 and 2002-227877 discloses the so-called one-way clutch mechanism transmitting the rotation of the rotating portion to the base portion when the rotating portion rotates in a prescribed direction while not transmitting the rotation of the rotating portion to the base portion when the rotating portion rotates in a direction opposite to the prescribed direction. A first end of the clutch spring is fixed to the base portion while a second end thereof is fixed to a cylindrical portion so mounted as to enclose the clutch spring, so that force is applied to the cylindrical portion in the direction for increasing the inner diameter of the clutch spring with electrically or mechanically controlled means provided independently of the clutch mechanism when the rotation is transmitted from the rotating portion to the base portion, thereby forcibly increasing the inner diameter of the clutch spring and idling the rotating portion.

The aforementioned Japanese Patent Laying-Open No. 06-330962 discloses a spring clutch controlling rotation of a roller shaft through adhesion of a clutch spring when transmitting rotational motion caused by driving force received from a driving source to the roller shaft wound with the clutch spring. In the spring clutch according to the aforementioned Japanese Patent Laying-Open No. 06-330962, an end of the clutch spring is fixed to a groovelike engaging portion of a worm wheel so arranged as to cover the clutch spring, and a coil portion is wound on the roller shaft in close contact therewith. When the worm wheel rotates by the driving force received from the driving source, therefore, torque is transmitted to the clutch spring through the engaging portion. When the worm wheel rotates in a direction for reducing the inner diameter of the clutch spring, adhesion between the clutch spring and the roller shaft is so increased that the roller shaft rotates by the rotational motion transmitted from the clutch spring. When the worm wheel rotates in a direction for increasing the inner diameter of the clutch spring, on the other hand, the adhesion between the clutch spring and the roller shaft is reduced to idle the clutch spring.

The aforementioned Japanese Patent Laying-Open No. 05-157125 discloses a clutch mechanism having a structure obtained by arranging a plurality of columnar pins on the outer periphery of a rotating shaft to be capable of rolling and inserting the rotating shaft provided with the pins into a ratchet member and a feed roller having grooves of a specific shape for receiving the pins in the inner peripheries thereof. This clutch mechanism further comprises a coil spring so interposed between the ratchet member and the feed roller that both ends thereof are fixed to the ratchet member and the feed roller respectively, so that engaging force between the pins and the grooves of the specific shape can be adjusted through the elastic force of the coil spring. In this clutch mechanism, the rotating shaft so rotates that the pins roll on the outer periphery of the rotating shaft in a rotational direction and press surfaces of the specific grooves on the side of the rotational direction, whereby the ratchet member and the feed roller rotate in the rotational direction of the rotating shaft. If the rotation of the ratchet member is regulated with ratchet control means at this time, the grooves of the ratchet member so regulate the motion of the pins rolling in the rotational direction along the outer periphery of the rotating shaft that the plurality of pins rotate on the axes thereof on prescribed positions respectively. Thus, the pins do not press the surfaces of the grooves of the feed roller on the side of the rotational direction so that no rotational motion is transmitted to the feed roller, thereby idling the rotating shaft.

However, the clutch according to each of the aforementioned Japanese Patent Laying-Open Nos. 2004-92759 and 2002-227877 must be separately provided with means other than the electrically or mechanically controlled means for applying the force to the cylindrical portion in the direction for forcibly increasing the inner diameter of the clutch spring, in order to idle the rotating portion, rotating by the driving force received from the driving source and transmitting the rotation to the base portion, thereby preventing the rotation from transmission to the base portion.

The clutch according to the aforementioned Japanese Patent Laying-Open No. 06-330962 cannot prevent the rotational motion from transmission to the destination while allowing the driving source to maintain the rotation in a transmittable direction when the roller shaft rotates through the rotational motion transmitted thereto by the rotation of the worm wheel in the direction for reducing the inner diameter of the clutch spring.

The clutch mechanism according to the aforementioned Japanese Patent Laying-Open No. 05-157125 must be separately provided with the ratchet control means for regulating the rotation of the ratchet member, in order to idle the rotating shaft.

### SUMMARY OF THE INVENTION

The present invention has been proposed in order to solve the aforementioned problems, and an object of the present invention is to provide an image generating apparatus capable of preventing rotational motion from transmission to the destination while allowing a driving source to maintain rotation in a transmittable direction with no requirement for separate means for loosening the rotation caused by driving force received from the driving source.

An image generating apparatus according to a first aspect of the present invention comprises a take-up portion for taking up an ink sheet, a driving source for driving the take-up portion and a rotating shaft rotatably receiving the take-up portion, the take-up portion includes a gear portion rotating in a prescribed direction by driving force received from the driving source, a take-up reel, having a first spring mount portion, for taking up the ink sheet and a torque generation spring member, interposed between the gear portion and the take-up reel, having a first end engaging with the gear portion and a coil portion so mounted on the first spring mount portion of the take-up reel as to come into close contact therewith prescribed adhesion, and load torque in a direction for increasing the inner diameter of the coil portion is applied to the torque generation spring member when the take-up reel takes up the ink sheet, while the torque generation spring member so idles with respect to the first spring mount portion of the take-up reel as not to transmit the rotational motion of the gear portion to the take-up reel if load torque exceeding a prescribed level is applied to the take-up reel.

As hereinabove described, the image generating apparatus according to the first aspect comprises the take-up portion for taking up the ink sheet, the driving source for driving the take-up portion and the rotating shaft rotatably receiving the take-up portion while the take-up portion includes the gear portion rotating in the prescribed direction by the driving force received from the driving source, the take-up reel, having the first spring mount portion, for taking up the ink sheet and the torque generation spring member, interposed between the gear portion and the take-up reel, having the first end engaging with the gear portion and the coil portion so mounted on the first spring mount portion of the take-up reel as to come into close contact therewith prescribed adhesion, whereby no slipping takes place between the torque generation spring member and the first spring mount portion of the take-up reel but the rotational motion is so transmitted that the take-up reel rotates in a single direction when the load torque is less than the prescribed level. Further, the load torque in the direction for increasing the inner diameter of the coil portion is applied to the torque generation spring member when the take-up reel takes up the ink sheet while the torque generation spring member so idles with respect to the first spring mount portion of the take-up reel as not to transmit the rotational motion of the gear portion to the take-up reel if load torque exceeding the prescribed level is applied to the take-up reel, whereby slipping automatically takes place between the torque generation spring member and the first spring mount portion of the take-up reel when torque exceeding the prescribed level is applied to the take-up reel. Thus, the rotational motion can be prevented from transmission to the destination (take-up reel) while the driving source maintains the rotation in a transmittable direction, without separately providing means for loosening the rotation caused by the driving force received from the driving source.

In the aforementioned image generating apparatus according to the first aspect, the gear portion preferably includes an engaging portion engaging with the first end of the torque generation spring member, and the first end of the torque generation spring member is preferably so formed as to outwardly protrude in the radial direction of the coil portion, while a second end of the torque generation spring member is preferably arranged to be rotatable with respect to the first spring mount portion of the take-up reel. According to this structure, the first end of the torque generation spring member engaging with the engaging portion of the gear portion due to the rotation of the gear portion receives force in the direction for increasing the inner diameter of the coil portion of the torque generation spring member when load torque exceeding the prescribed level is applied to the take-up reel, whereby the adhesion between the torque generation spring member and the take-up reel can be so reduced that the torque generation spring member idles with respect to the first spring mount portion of the take-up reel.

In this case, the engaging portion of the gear portion preferably includes a notch, and the first end of the torque generation spring member is preferably so formed as to engage with the notch of the gear portion. According to this structure, the first end of the torque generation spring member can engage with the gear portion through the easily formable notch.

In the aforementioned structure having the second end of the torque generation spring member arranged to be rotatable with respect to the first spring mount portion of the take-up reel, the second end of the torque generation spring member is preferably so formed as to extend toward a direction for separating from the first spring mount portion of the take-up reel. According to this structure, the second end of the torque generation spring member can be inhibited from coming into contact with the first spring mount portion, whereby the second end can be inhibited from hindering rotation of the torque generation spring member by coming into contact with the first spring mount portion when the torque generation spring member rotates with respect to the first spring portion.

In the aforementioned image generating apparatus according to the first aspect, the inner radius of the coil portion of the torque generation spring member in a state not mounted on the first spring mount portion is preferably smaller than the radius of the outer periphery of the first spring mount portion while torque generated by the torque generation spring member is preferably controlled by controlling the difference between the inner radius of the coil portion and the radius of the outer periphery of the first spring mount portion. According to this structure, prescribed torque for preventing the rotational motion of the gear portion from transmission to the take-up reel can be easily controlled.

In the aforementioned image generating apparatus according to the first aspect, the take-up portion preferably further includes a one-way spring for rotating the take-up portion only in a single direction, in addition to the torque generation spring member. According to this structure, the rotational motion can be prevented from transmission to the destination (take-up reel) while the driving source maintains the rotation in the transmittable direction with the torque generation spring member, and the one-way spring can prevent the take-up reel from rotating in the opposite direction.

In the aforementioned image generating apparatus according to the first aspect, the gear portion preferably has a second spring mount portion, and the one-way spring is preferably mounted on the second spring mount portion of the gear portion so that a hooked first end thereof engages with a spring engaging portion. Thus, the gear portion is rotatable only in a single direction, whereby the take-up reel interlocked with the gear portion can be easily rendered rotatable only in the single direction. Consequently, the ink sheet can be easily prevented from reverse winding.

In this case, the gear portion preferably has a one-way spring slippage regulating portion on an end of the second spring mount portion. According to this structure, the one-way spring mounted on the second spring mount portion can be inhibited from slipping off the second spring mount portion.

In the aforementioned structure provided with the gear portion having the one-way spring slippage regulating portion, the gear portion preferably further has an engaging portion engaging with the first end of the torque generation spring member, and the engaging portion, the second spring mount portion and the one-way spring slippage regulating portion are preferably integrally formed on the gear portion. According to this structure, no additional members may be employed for providing the engaging portion, the second spring mount portion and the one-way spring slippage regulating portion on the gear portion, whereby the number of components can be inhibited from increase.

In the aforementioned image generating apparatus according to the first aspect, the take-up reel preferably has a shaft portion rotatably inserted into an insertion portion of the gear portion, and the take-up portion preferably further includes a regulating member for inhibiting the shaft portion from moving in a direction for coming off the insertion portion. According to this structure, the shaft portion can be inhibited from coming off the insertion portion, whereby the take-up reel can be inhibited from slipping off the gear portion.

An image generating apparatus according to a second aspect of the present invention comprises a take-up portion for taking up an ink sheet, a rotating shaft rotatably receiving the take-up portion and a driving source for driving the take-up portion, the take-up portion includes a gear portion rotating in a prescribed direction by driving force received from the driving source, a take-up reel, having a first spring mount portion, for taking up the ink sheet, a torque generation spring member, interposed between the gear portion and the take-up reel, having a first end engaging with the gear portion and a coil portion so mounted on the first spring mount portion of the take-up reel as to come into close contact therewith prescribed adhesion and a one-way spring for rotating the take-up portion only in a single direction, load torque in a direction for increasing the inner diameter of the coil portion is applied to the torque generation spring member when the take-up reel takes up the ink sheet while the torque generation spring member so idles with respect to the first spring mount portion of the take-up reel as not to transmit the rotational motion of the gear portion to the take-up reel if load torque exceeding a prescribed level is applied to the take-up reel, the gear portion has an engaging portion engaging with the first end of the torque generation spring member, the first end of the torque generation spring member is so formed as to outwardly protrude in the radial direction of the coil portion while a second end of the torque generation spring member is arranged to be rotatable with respect to the first spring mount portion of the take-up reel, the inner radius of the coil portion of the torque generation spring member in a state not mounted on the first spring mount portion is smaller than the radius of the outer periphery of the first spring mount portion while torque generated by the torque generation spring member is controlled by controlling the difference between the inner radius of the coil portion and the radius of the outer periphery of the first spring mount portion, the gear portion has a second spring mount portion, and the one-way spring is mounted on the second spring mount portion of the gear portion so that a hooked first end thereof engages with a spring engaging portion.

As hereinabove described, the image generating apparatus according to the second aspect comprises the take-up portion for taking up the ink sheet, the driving source for driving the take-up portion and the rotating shaft rotatably receiving the take-up portion while the take-up portion includes the gear portion rotating in the prescribed direction by the driving force received from the driving source, the take-up reel, having the first spring mount portion, for taking up the ink sheet and the torque generation spring member, interposed between the gear portion and the take-up reel, having the first end engaging with the gear portion and the coil portion so mounted on the first spring mount portion of the take-up reel as to come into close contact therewith prescribed adhesion, whereby no slipping takes place between the torque generation spring member and the first spring mount portion of the take-up reel but the rotational motion is so transmitted that the take-up reel rotates in a single direction when the load torque is less than the prescribed level. Further, the load torque in the direction for increasing the inner diameter of the coil portion is applied to the torque generation spring member when the take-up reel takes up the ink sheet while the torque generation spring member so idles with respect to the first spring mount portion of the take-up reel as not to transmit the rotational motion of the gear portion to the take-up reel if load torque exceeding a prescribed level is applied to the take-up reel, whereby slipping automatically takes place between the torque generation spring member and the first spring mount portion of the take-up reel when torque exceeding the prescribed level is applied to the take-up reel. Thus, the rotational motion can be prevented from transmission to the destination (take-up reel) while the driving source maintains the rotation in the transmittable direction, without separately providing means for loosening the rotation caused by the driving force received from the driving source. Further, the gear portion includes the engaging portion engaging with the first end of the torque generation spring member and the first end of the torque generation spring member is so formed as to outwardly protrude in the radial direction of the coil portion while the second end of the torque generation spring member is arranged to be rotatable with respect to the first spring mount portion of the take-up reel so that the first end of the torque generation spring member engaging with the engaging portion of the gear portion due to the rotation of the gear portion receives force in the direction for increasing the inner diameter of the coil portion of the torque generation spring member when load torque exceeding the prescribed level is applied to the take-up reel, whereby the adhesion between the torque generation spring member and the take-up reel can be so reduced that the torque generation spring member idles with respect to the first spring mount portion of the take-up reel. In addition, the inner radius of the coil portion of the torque generation spring member in the state not mounted on the first spring mount portion is smaller than the radius of the outer periphery of the first spring mount portion while the torque generated by the torque generation spring member is controlled by controlling the difference between the inner radius of the coil portion and the radius of the outer periphery of the first spring mount portion, whereby prescribed torque for preventing the rotational motion of the gear portion from transmission to the take-up reel can be easily controlled. Further, the take-up portion further includes the one-way spring for rotating the take-up portion only in the single direction in addition to the torque generation spring member, whereby the rotational motion can be prevented from transmission to the destination (take-up reel) while the driving source maintains the rotation in the transmittable direction with the torque generation spring member, and the one-way spring can prevent the take-up reel from rotating in the opposite direction. Further, the gear portion has the second spring mount portion, and the one-way spring is mounted on the second spring mount portion of the gear portion so that the hooked first end thereof engages with the spring engaging portion. Thus, the gear portion is rotatable only in a single direction, whereby the take-up reel interlocked with the gear portion can be easily rendered rotatable only in the single direction. Consequently, the ink sheet can be easily prevented from reverse winding.

In the aforementioned image generating apparatus according to the second aspect, the engaging portion of the gear portion preferably includes a notch, and the first end of the torque generation spring member is preferably so formed as to engage with the notch of the gear portion. According to this structure, the first end of the torque generation spring member can engage with the gear portion through the easily formable notch.

In the aforementioned image generating apparatus according to the second aspect, the second end of the torque generation spring member is preferably so formed as to extend toward a direction for separating from the first spring mount portion of the take-up reel. According to this structure, the second end of the torque generation spring member can be inhibited from coming into contact with the first spring mount portion, whereby the second end can be inhibited from hindering rotation of the torque generation spring member by coming into contact with the first spring mount portion when the torque generation spring member rotates with respect to the first spring portion.

In the aforementioned image generating apparatus according to the second aspect, the gear portion preferably has a one-way spring slippage regulating portion on an end of the second spring mount portion. According to this structure, the one-way spring mounted on the second spring mount portion can be inhibited from slipping off the second spring mount portion.

In this case, the gear portion preferably further has an engaging portion engaging with the first end of the torque generation spring member, and the engaging portion, the second spring mount portion and the one-way spring slippage regulating portion are preferably integrally formed on the gear portion. According to this structure, no additional members may be employed for providing the engaging portion, the second spring mount portion and the one-way spring slippage regulating portion on the gear portion, whereby the number of components can be inhibited from increase.

In the aforementioned image generating apparatus according to the second aspect, the take-up reel preferably has a shaft portion rotatably inserted into an insertion portion of the gear portion, and the take-up portion preferably further includes a regulating member for inhibiting the shaft portion from moving in a direction for coming off the insertion portion. According to this structure, the shaft portion can be inhibited from coming off the insertion portion, whereby the take-up reel can be inhibited from slipping off the gear portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of a sublimatic printer according to an embodiment of the present invention;

FIG. 2 is a front elevational view showing motors and gears of the sublimatic printer according to the embodiment of the present invention shown in FIG. 1;

FIG. 3 is a perspective view of the sublimatic printer according to the embodiment of the present invention shown in FIG. 1 as viewed from the side of a second side surface of a chassis;

FIG. 4 is a perspective view showing an ink sheet take-up portion and a motor bracket of the sublimatic printer according to the embodiment of the present invention shown in FIG. 1;

FIG. 5 is an exploded perspective view of the ink sheet take-up portion, the motor bracket and an ink sheet cartridge of the sublimatic printer according to the embodiment of the present invention shown in FIG. 1;

FIG. 6 is a plan view of the ink sheet take-up portion and the motor bracket of the sublimatic printer according to the embodiment of the present invention shown in FIG. 1;

FIG. 7 is a front elevational view of the ink sheet take-up portion and the motor bracket of the sublimatic printer according to the embodiment of the present invention shown in FIG. 1;

FIG. 8 is an exploded perspective view of the ink sheet take-up portion of the sublimatic printer according to the embodiment of the present invention shown in FIG. 1;

FIG. 9 is a sectional view of the ink sheet take-up portion and the motor bracket of the sublimatic printer according to the embodiment of the present invention shown in FIG. 1;

FIG. 10 is a diagram for illustrating the structure of a torque generation spring of the sublimatic printer according to the embodiment of the present invention shown in FIG. 1;

FIG. 11 is a diagram showing a state in attachment of the ink sheet cartridge in the sublimatic printer according to the embodiment of the present invention shown in FIG. 1; and

FIGS. 12 and 13 are diagrams for illustrating the procedure of assembling the ink sheet take-up portion of the sublimatic printer according to the embodiment of the present invention shown in FIG. 1.

### DESCRIPTION OF PREFERRED EMBODIMENTS

An embodiment of the present invention is now described with reference to the drawings.

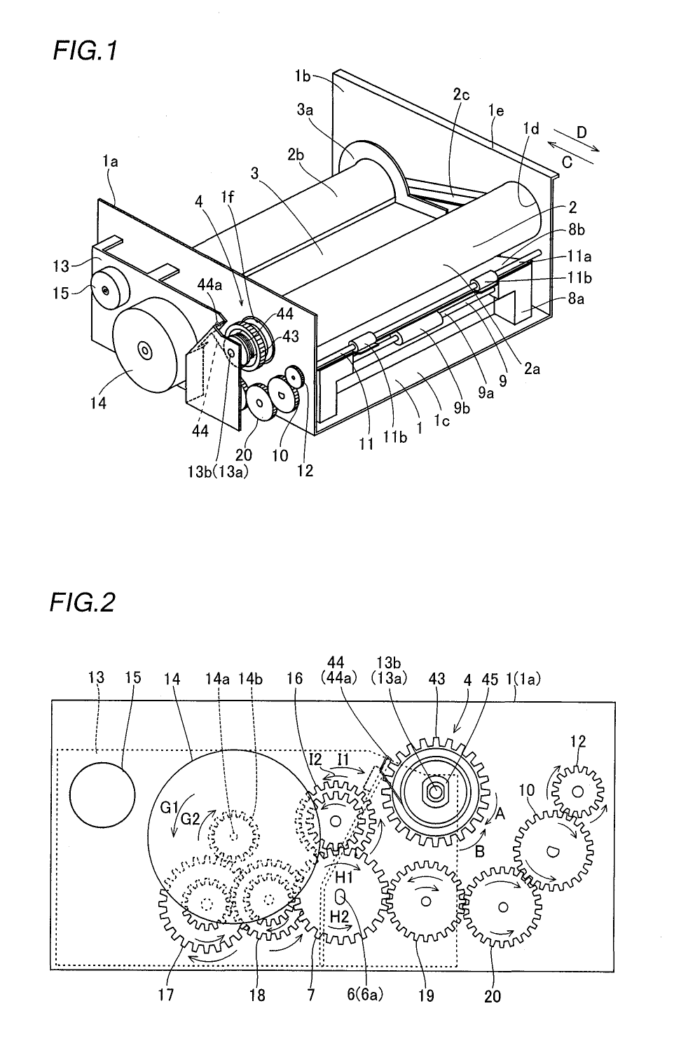

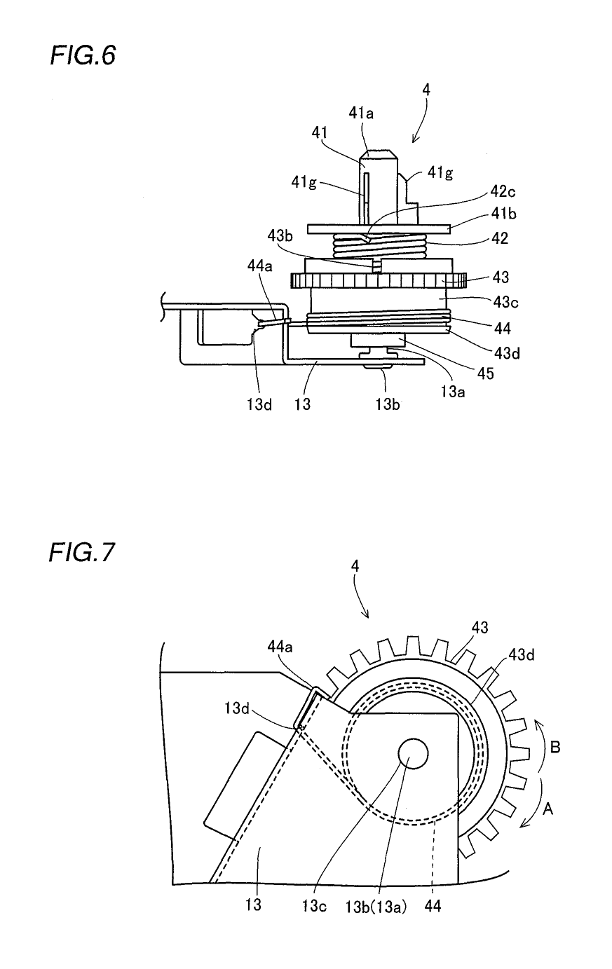

First, the structure of a sublimatic printer according to the embodiment of the present invention is described with reference to FIGS. 1 to 11. According to this embodiment, the present invention is applied to the sublimatic printer, which is an example of the image generating apparatus.

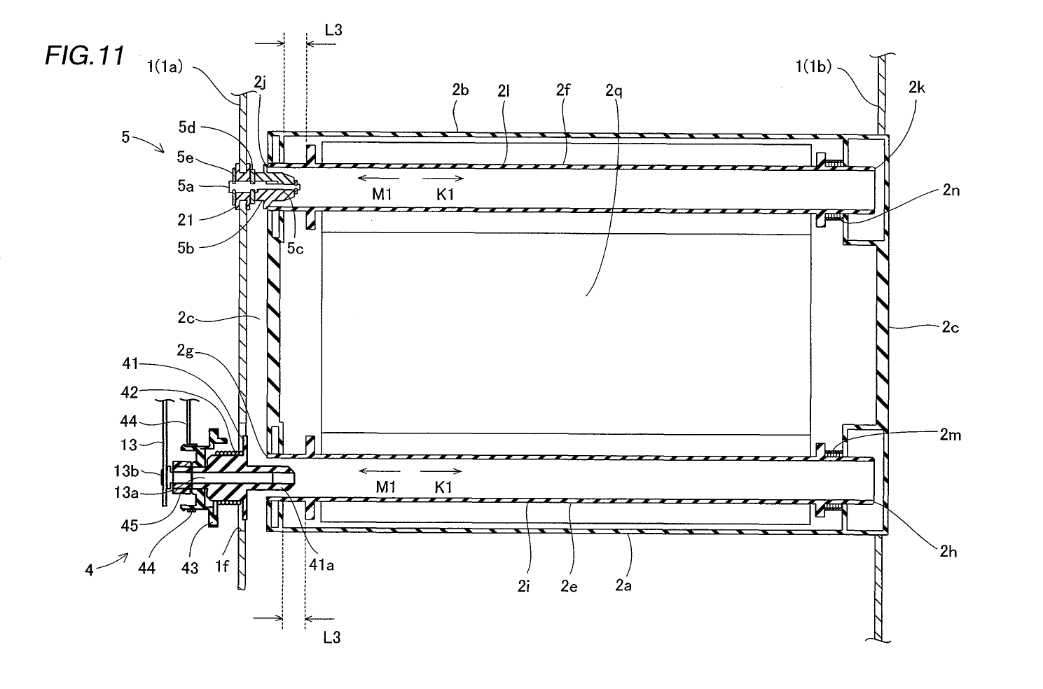

As shown in FIGS. 1 to 3, the printer body of the sublimatic printer according to this embodiment comprises a chassis 1 of metal, a print head 3 for performing printing in a state where an ink sheet cartridge 2 for storing an ink sheet 2q is attached to the printer body, an ink sheet take-up portion 4 (see FIGS. 1 and 2) and an ink sheet supply portion 5 (see FIG. 11) engaging with the ink sheet cartridge 2, a feed roller 6 (see FIG. 2), a feed roller gear 7 (see FIG. 2), a lower paper guide 8a of resin, an upper paper guide 8b of resin, a paper feed roller 9, a paper feed roller gear 10, a paper discharge roller 11, a paper discharge roller gear 12, a motor bracket 13, a stepping motor 14 for transporting papers, another stepping motor 15 serving as a driving source for rotating the print head 3, a swingable swing gear 16 (see FIG. 2) and a plurality of intermediate gears 17 to 20 (see FIG. 2).

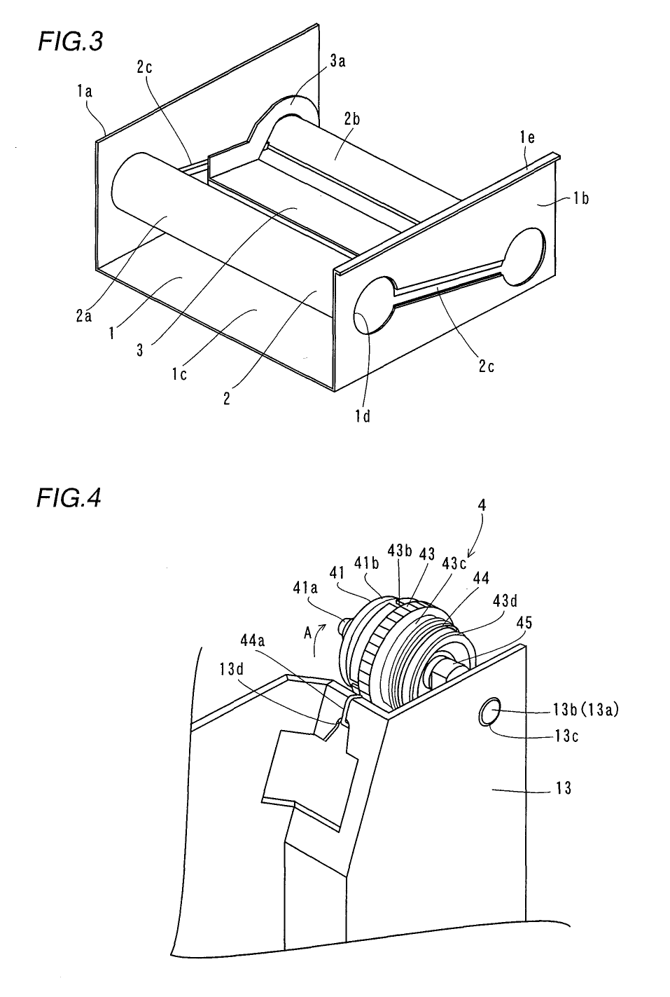

The chassis 1 has a first side surface 1a, a second side surface 1b and a bottom surface 1c, as shown in FIG. 1. The aforementioned motor bracket 13 is mounted on the first side surface 1a of the chassis 1, as shown in FIGS. 1 and 3. A receiving hole 1d for receiving eh ink sheet cartridge 2 and a folded portion 1e are provided on the second side surface 1b of the chassis 1. An opening 1f for arranging the ink sheet take-up portion 4 is provided on the first side surface 1a of the chassis 1, as shown in FIG. 1.

The print head 3 for performing printing has an arm portion 3a, as shown in FIGS. 1 and 3. This print head 3 is mounted inside the first and second side surfaces 1a and 1b of the chassis 1, to be rotatable about a support shaft (not shown) engaging with an end (not shown) of the arm portion 3a.

The ink sheet supply portion 5 includes a rotating shaft 5a of metal, a supply bobbin engaging portion 5b of resin mounted on a first end of the rotating shaft 5a, a stopping snap ring 5c of metal and position-control snap rings 5d and 5e, as shown in FIG. 11. The rotating shaft 5a is rotatably mounted on the first side surface 1a of the chassis 1 by a bearing member 21, while the axial position thereof is controlled by the position-control snap rings 5d and 5e.

The feed roller 6 is so formed as to rotate following rotation of the feed roller gear 7, and has a function of holding each paper between the same and a press roller (not shown) thereby transporting the paper in a paper feed direction (along arrow C in FIG. 1) and a paper discharge direction (along arrow D in FIG. 1). This feed roller 6 includes a gear insertion portion 6a inserted into the feed roller gear 7, as shown in FIG. 2.

The lower paper guide 8a is set in the vicinity of the paper feed roller 9, as shown in FIG. 1. This lower paper guide 8a has a function of passing each paper fed by the paper feed roller 9 through the upper surface of the lower paper guide 8a thereby guiding the paper to a feed passage toward the print head 3.

The upper paper guide 8b is supported by the lower paper guide 8a. This upper paper guide 8b is supported in a state inclined by a prescribed angle with respect to the bottom surface 1c of the chassis 1. Thus, the upper paper guide 8b has a function of passing each paper transported by the feed roller 6 through the upper surface of the upper paper guide 8b in a state inclined by the prescribed angle thereby guiding the paper to a discharge passage toward the paper discharge roller 11.

The paper discharge roller 11 is provided for discharging each paper subjected to printing with the print head 3. This paper discharge roller 11 has a shaft portion 11a of metal and a roller portion 11b of rubber fitted into the shaft portion 11a, as shown in FIG. 1. The paper discharge roller gear 12 is mounted on an end of the shaft portion 11a of the paper discharge roller 11 closer to the first side surface 1a.

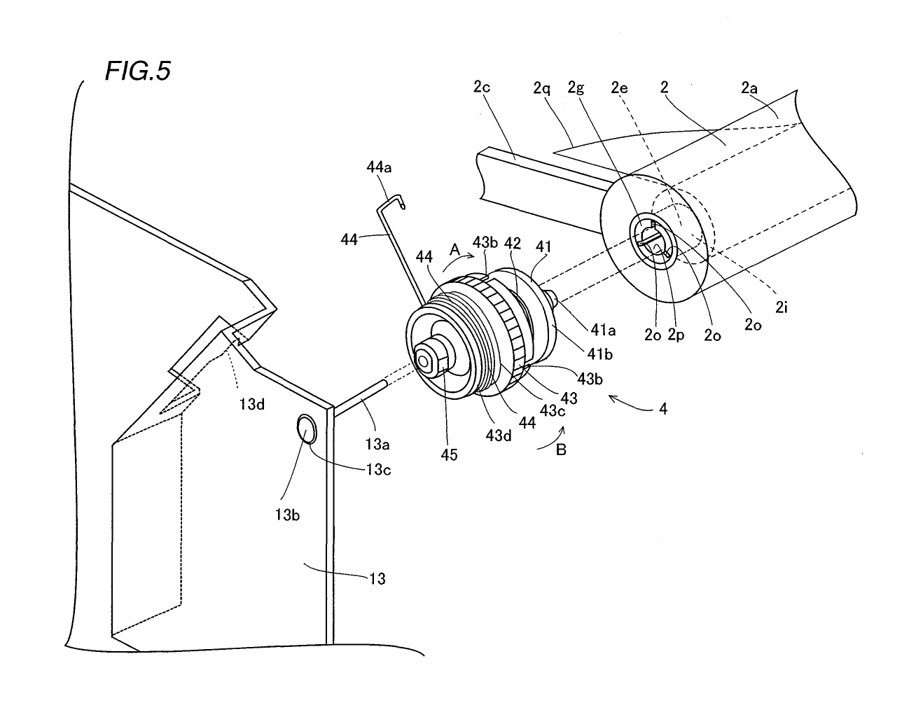

According to this embodiment, the motor bracket 13 includes a one-way spring engaging portion 13d having a concave recess as shown in FIGS. 4 to 7, so that a first end 44a of a one-way spring 44 described later engages with the one-way spring engaging portion 13d. The first end 44a of the one-way spring 44 is so hooked as to be fixed to the one-way spring engaging portion 13d in a caught state.

As shown in FIG. 2, a motor gear 14b is mounted on a shaft portion 14a of the stepping motor 14 mounted on the motor bracket 13. The stepping motor 14 functions as a driving source for driving a gear portion 43 included in the ink sheet take-up portion 4, the feed roller gear 7, the paper feed roller gear 10, the paper discharge roller gear 12 and the intermediate gears 17 to 20. On the other hand, the stepping motor 15 functions as a driving source for rotating a pressing member (not shown) for pressing the print head 3 against a platen roller (not shown) through a gear (not shown).

The ink sheet cartridge 2 has a take-up portion 2a, a supply portion 2b and a coupling portion 2c, as shown in FIGS. 1 and 3. As shown in FIG. 11, a take-up bobbin 2e is rotatably arranged in the take-up portion 2a of the ink sheet cartridge 2, to be movable along arrow K1 in FIG. 11 by a discharge stroke (L3 in FIG. 11). Further, a supply bobbin 2f is rotatably arranged in the supply portion 2b of the ink sheet cartridge 2, to be movable along arrow K1 in FIG. 11 by the discharge stroke (L3 in FIG. 11). The take-up bobbin 2e has a first end 2g, a second end 2h and a shaft portion 2i, as shown in FIG. 11. The supply bobbin 2f also has a first end 2j, a second end 2k and a shaft portion 2l. The firs ends 2g and 2j of the take-up bobbin 2e and the supply bobbin 2f protrude from the ink sheet cartridge 2 toward the first side surface 1a of the chassis 1 (along arrow M1 in FIG. 11) by the discharge stroke (L3 in FIG. 11) respectively.

As shown in FIG. 11, further, compression springs 2m and 2n are mounted in the vicinity of the second ends 2h and 2k of the take-up bobbin 2e and the supply bobbin 2f respectively. The compression springs 2m and 2n have functions of urging the take-up bobbin 2e and the supply bobbin 2f toward the ink sheet take-up portion 4 and the ink sheet supply portion 5 (along arrow M1 in FIG. 11) respectively. Further, the compression springs 2m and 2n also have functions for generating force for moving the ink sheet cartridge 2 in a discharge direction (along arrow K1 in FIG. 11) by the discharge stroke (L3 in FIG. 11) when the ink sheet cartridge 2 is discharged. The first end 2g of the take-up bobbin 2e is provided with a recess portion 2p having three grooves 20, as shown in FIG. 5. The first end 2j of the supply bobbin 2f is also provided with a recess portion (not shown) having three grooves, similarly to the first end 2g of the take-up bobbin 2e. The ink sheet 2q is wound on the shaft portions 2i and 2l of the take-up bobbin 2e and the supply bobbin 2f, as shown in FIGS. 5 and 11.

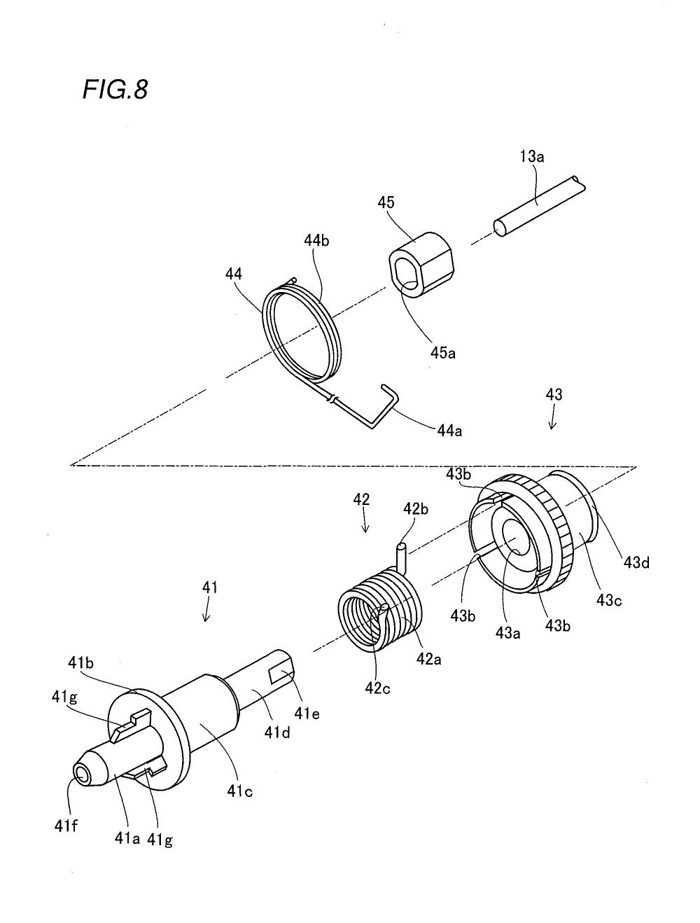

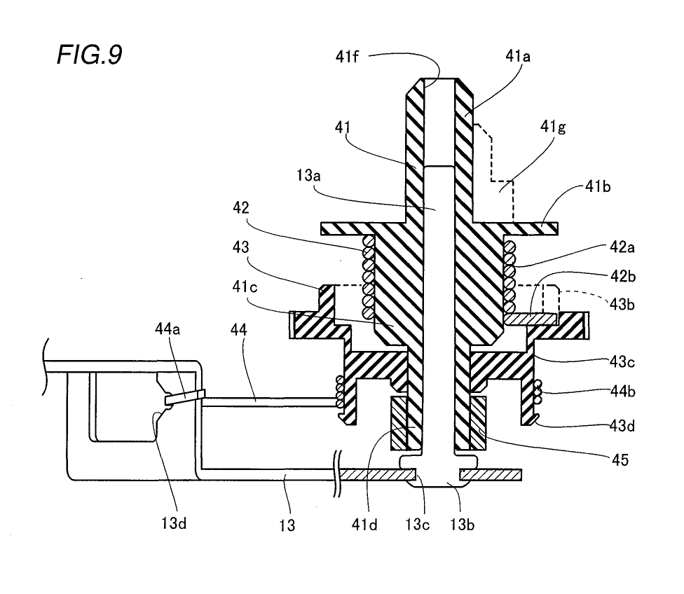

The ink sheet take-up portion 4 is provided for taking up the ink sheet 2q (see FIG. 5) by rotating through the driving force received from the stepping motor 14. According to this embodiment, the ink sheet take-up portion 4 is rotatably mounted on a rotating shaft 13a having a first end 13b fixed to a shaft fixing portion 13c of the bracket 13 by caulking, as shown in FIGS. 5 to 9. This ink sheet take-up portion 4 includes a take-up reel 41 of resin, a torque generation spring 42 in the form of a coil, the gear portion 43, the one-way spring 44 and a reel cap 45, as shown in FIGS. 8 and 9. The reel cap 45 is an example of the “regulating member” in the present invention.

The take-up reel 41 has a take-up bobbin engaging portion 41a, a plate portion 41b formed integrally with the take-up bobbin engaging portion 41a, a spring mount portion 41c for mounting the torque generation spring 42, a shaft portion 41d inserted into the gear portion 43, a cap engaging portion 41e engaging with the reel cap 45 and a hole 41f for receiving the rotating shaft 13a of the motor bracket 13. The take-up bobbin engaging portion 41a of the take-up reel 41 is provided with three engaging pawls 41g engaging with the three grooves 20 of the take-up bobbin 2e (see FIG. 5) respectively. The spring mount portion 41c and the torque generation spring 42 are examples of the “first spring mount portion” and the “torque generation spring member” in the present invention respectively.

The reel cap 45 includes an engaging hole 45a receiving the cap engaging portion 41e of the take-up reel 41, and is press-fitted with the cap engaging portion 41e for preventing the take-up reel 41 from slipping off the gear portion 43. More specifically, the reel cap 45 is so formed as to inhibit the shaft portion 41c of the take-up reel 41 from moving in a direction for coming off an insertion portion 43a of the gear portion 43, in order to inhibit the shaft portion 41c from slipping off the insertion portion 43a.

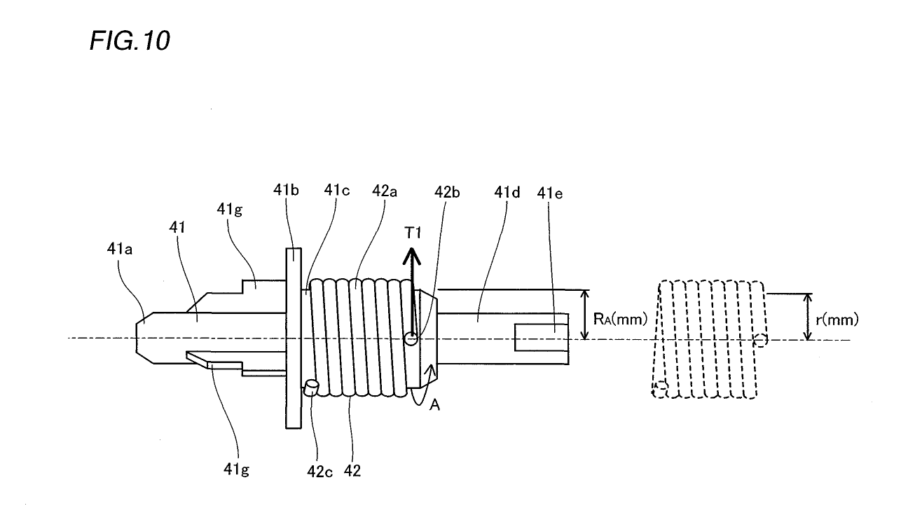

According to this embodiment, the torque generation spring 42 is provided with a coil portion 42a to be wound on the spring mount portion 41c of the take-up reel 41 in close contact therewith, and includes a gear engaging portion 42b outwardly protruding in the radial direction of the coil portion 42a on a first end thereof. A second end 42c of the torque generation spring 42 is formed unfixed to the spring mount portion 41c. More specifically, the second end 42c of the torque generation spring 42 is so formed as to extend in a direction for separating from the spring mount portion 41c of the take-up reel 41. The inner diameter (radius r (mm)) of the coil portion 42a of the torque generation spring 42 is smaller than the outer diameter (radius R_{A} (mm)) of the spring mount portion 41c of the take-up reel 41 in a state where the torque generation spring 42 is not attached to the spring take-up portion 41c of the take-up reel 41, as shown in FIG. 10. Thus, adhesion (slip torque) can be ensured between the torque generation spring 42 and the spring take-up portion 41c. This point is described later in detail.

The gear portion 43 has the insertion portion 43a for receiving the shaft portion 41d of the take-up reel 41, a notched spring engaging portion 43b so formed as to engage with the gear engaging portion 42b of the torque generation spring 42, a one-way spring mount portion 43c wound with the one-way spring 44, and a rib 43d for preventing the one-way spring 44 from slipping off the gear portion 43. The rib 43d is integrally provided on an end of the one-way spring mount portion 43c closer to the motor bracket 13 (shaft fixing portion 13c), as shown in FIG. 9. The rib 43d is an example of the “one-way spring slippage regulating portion” in the present invention. The gear portion 43 has a function of rotating the ink sheet take-up portion 4 by the driving force transmitted thereto from the stepping motor 14.

According to this embodiment, the take-up reel 41, the torque generation sprint 42, the gear portion 43, the one-way spring 44 and the reel cap 45 constitute the ink sheet take-up portion 4. Thus, the take-up reel 41, the torque generation spring 42 and the gear portion 43 integrally rotate due to friction between the spring mount portion 41c of the take-up reel 41 and the coil portion 42a of the torque generation spring 42 and engagement between the gear engaging portion 42b of the torque generation spring 42 and the spring engaging portion 43b of the gear portion 43. The spring engaging portion 43b is an example of the “notch” in the present invention.

According to this embodiment, the first end 44a of the one-way spring 44 is so hooked as to be fixed to the one-way spring engaging portion 13d of the motor bracket 13 by engagement, as shown in FIGS. 4, 6 and 7. As shown in FIG. 2, the one-way spring 44 has a spring take-up direction for reducing the inner diameter of the spring portion 44b when rotating oppositely (along arrow B) to the rotational direction (along arrow A) of the ink sheet take-up portion 4 taking up the ink sheet 2q. In other words, this one-way spring 44 has a function of controlling the ink sheet take-up portion 4 so as to rotate only in the rotational direction (along arrow A) of the ink sheet take-up portion 4 taking up the ink sheet 2q. More specifically, the first end 44a of the one-way spring 44 engages with the one-way spring engaging portion 13d of the motor bracket 13, whereby the inner diameter of the spring portion 44b of the one-way spring 44 is reduced due to frictional force between the one-way spring 44 and the surface (outer peripheral surface) of the one-way spring mount portion 43c when the ink sheet take-up portion 4 is going to rotate oppositely (along arrow B) to the rotational direction for taking up the ink sheet 2q. Thus, the one-way spring 44 clamps the one-way spring mount portion 43c, thereby inhibiting the gear portion 43 from rotating in the direction B. As hereinabove described, the take-up reel 41 and the gear portion 43 integrally rotate through the torque generation spring 42. When rotation of the gear portion 43 is regulated, therefore, rotation of the overall ink sheet take-up portion 4 is also regulated.

According to this embodiment, the torque generation spring 42 has a take-up direction for increasing the inner diameter of the coil portion 42a by torque transmitted from the gear portion 43 to the gear engaging portion 42b when rotating in the rotational direction (along arrow A) allowing rotation of the ink sheet take-up portion 4, as shown in FIG. 10. Slip torque described later is so adjusted in an initial stage that the gear engaging portion 42b of the torque generation spring 42 mounted on the spring mount portion 41c of the take-up reel 41 in close contact therewith slips due to reduction in adhesion to the spring mount portion 41c by force applied by the spring engaging portion 43b of the gear portion 43 in the direction (along arrow T1 in FIG. 10) for increasing the inner diameter of the coil portion 42a when load torque exceeding a prescribed level is applied to the take-up bobbin engaging portion 41a of the take-up reel 41. When the load torque exceeding the prescribed level is applied to the take-up bobbin engaging portion 41a of the take-up reel 41, therefore, the take-up reel 41 remains unrotating despite rotation of the gear portion 43. In other words, the torque generation spring 42 functions as a torque limiter.

According to this embodiment, as hereinabove described, the rib 43d is circumferentially provided on the end of the one-way spring mount portion 43c of the gear portion 43 closer to the motor bracket 13 (shaft fixing portion 13c). Further, the first end 44a of the one-way spring 44 is fixed to the one-way spring engaging portion 13d of the motor bracket 13. When the ink sheet take-up portion 4 including the one-way spring 44 is going to move in a direction for coming off the rotating shaft 13a, therefore, the one-way spring engaging portion 13d can inhibit the one-way spring 44 from moving in the direction where the ink sheet take-up portion 4 slips off the rotating shaft 13a while the circumferential rib 43d can inhibit the one-way spring 44 from slipping off the one-way spring mount portion 43c of the ink sheet take-up portion 4, whereby the ink sheet take-up portion 4 mounted with the one-way spring 44 can be inhibited from slipping off the rotating shaft 13a. Further, the circumferential rib 43d is so integrally provided on the one-way spring mount portion 43c that the ink sheet take-up portion 4 can be inhibited from slipping off the sublimatic printer without separately providing a stop member such as a snap ring.

The procedure of assembling the ink sheet take-up portion 4 of the sublimatic printer according to the embodiment of the present invention is now described with reference to FIGS. 8 to 10, 12 and 13.

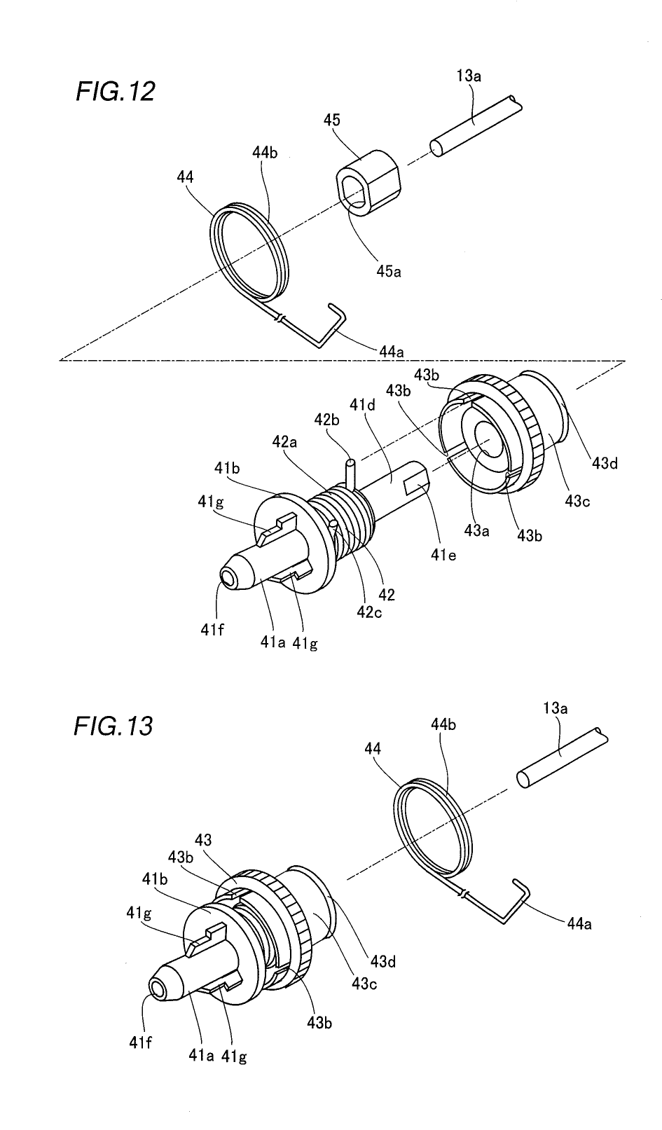

As shown in FIG. 8, the torque generation spring 42 is mounted on the spring mount portion 41c of the take-up reel 41 from the side of the second end 42c opposite to the gear engaging portion 42b, to be in close contact with the spring mount portion 41c with prescribed adhesion described later. Then, the shaft portion 41d of the take-up reel 41 mounted with the torque generation spring 42 is inserted into the insertion portion 43a of the gear portion 43 so that the gear engaging portion 42b of the torque generation spring 42 engages with the spring engaging portion 43b of the gear portion 43, as shown in FIG. 12. Thus, the oval cap engaging portion 41e of the shaft portion 41d is inserted into the insertion portion 43a of the gear portion 43, to pass through the gear portion 43 toward the motor bracket 13 (see FIG. 9). In this state, the reel cap 45 having the oval engaging hole 45a is press-fitted with the oval cap engaging portion 41e of the take-up reel 41. Thus, the take-up reel 41 can be prevented from slipping off the gear portion 43. Then, the one-way spring 44 is mounted on the one-way spring mount portion 34c of the gear portion 34 integrated with the take-up reel 41, the torque generation spring 42 and the reel cap 45 to be in close contact with the one-way spring mount portion 43c, as shown in FIG. 13.

As hereinabove described, the torque generation spring 42 must be mounted on the spring mount portion 41c of the take-up reel 41 with the prescribed adhesion. This prescribed adhesion is obtained by the following general formula of slip torque Ts:

Ts=EIδ(1−1/e^{2πμN})/R_{A}² (1)

In the above formula, Ts represents the slip torque (Nmm), E represents the modulus of longitudinal elasticity (N/mm²), I represents the geometrical moment of inertia (mm⁴), δ represents mount shaft-spring clamping quantity (mm), R_{A} represents the radius of the mount shaft (mm), e represents the natural logarithm, μ represents the coefficient of friction between the mount shaft and the spring, and N represents the number of active turns in winding. In the slip torque Ts (Nmm) obtained from the formula (1), the ratio of the mount shaft-spring clamping quantity δ is relatively larger than those of the remaining factors. The mount shaft-spring clamping quantity δ is obtained by the difference (=R_{A}−r:(R_{A}>r)) between the radius R_{A} (mm) of the spring mount portion 41c and the inner radius r (mm) of the coil portion 42a of the torque generation spring 42 shown in FIG. 10.

According to this embodiment, prescribed torque causing slipping between the spring mount portion 41c of the take-up reel 41 and the coil portion 42a of the torque generation spring 42 is previously set. At this time, the adhesion (slip torque Ts) between the spring mount portion 41c and the coil portion 42a of the torque generation spring 42 obtained through the formula (1) is controlled to the aforementioned prescribed level (slip torque Ts) by controlling the radius R_{A} (mm) of the spring mount portion 41c and the inner radius r (mm) of the coil portion 42a of the torque generation spring 42 shown in FIG. 10. The torque generation spring 42 is wound on the spring mount portion 41c with the adhesion (slip torque Ts) controlled in this manner. The adhesion (slip torque Ts) can also be controlled by controlling factors, other than those of the formula (1), such as the materials of the spring mount portion 41c and the torque generation spring 42.

A method of mounting the ink sheet take-up portion 4 of the sublimatic printer according to the embodiment of the present invention is described with reference to FIGS. 5 to 7.

First, the ink sheet take-up portion 4 is mounted on the rotating shaft 13a fixed to the motor bracket 13 with the one-way spring 44 mounted on the one-way spring mount portion 43c of the one-way spring 44, as shown in FIGS. 5 to 7. Then, the hooked first end 44a of the one-way spring 44 is fixed in the state engaging with the one-way spring engaging portion 13d of the motor bracket 13.

An operation of taking up the ink sheet 2q by the ink sheet take-up portion 4 of the sublimatic printer according to the embodiment of the present invention is described with reference to FIGS. 2, 5 and 11.

First, the stepping motor 14 is so driven that the motor gear 14d mounted on the shaft portion 14a of the stepping motor 14 rotates along arrow G1 in FIG. 2 and the feed roller gear 7 rotates along arrow H1 in FIG. 2 through the intermediate gears 17 and 18, as shown in FIG. 2. Thus, the swingable swing gear 16 swings in a direction (along arrow I1 in FIG. 2) for engaging with the gear portion 43 of the ink sheet take-up portion 4, and engages with the gear portion 43. Then, the gear portion 43 of the ink sheet take-up portion 4 rotates along arrow A (take-up direction) in FIG. 2.

At this time, the gear portion 43, the torque generation spring 42 and the take-up reel 41 so integrally rotate as described above that the take-up bobbin engaging portion 41a of the take-up reel 41 also rotates along arrow A. Consequently, the take-up bobbin 2e of the ink sheet cartridge 2 engaging with the take-up bobbin engaging portion 41a of the take-up reel 41 rotates along arrow A in FIG. 5, thereby taking up the ink sheet 2q.

The take-up bobbin 2e so takes up the ink sheet 2q that the supply bobbin 2f (see FIG. 11) wound with the ink sheet 2q and the ink sheet supply portion 5 (see FIG. 11) engaging with the supply bobbin 2f also rotate. When load torque exceeding the prescribed level set in the aforementioned manner is applied to the take-up bobbin engaging portion 41a of the take-up reel 41 in this case, the torque generation spring 42 wound on the spring mount portion 41c of the take-up reel 41 slips with respect to the take-up reel 41 (spring mount portion 41c), whereby the take-up reel 41 remains unrotating although the gear portion 43 keeps rotating.

Following the driving of the stepping motor 14, the motor gear 14b mounted on the shaft portion 14a of the stepping motor 14 rotates along arrow G2 in FIG. 2, and the feed roller gear 7 rotates along arrow H2 in FIG. 2 through the intermediate gears 17 and 18. Thus, the swingable swing gear 16 swings in a direction (along arrow 12 in FIG. 2) for separating from the gear portion 43 of the ink sheet take-up portion 4.

When the swing gear 16 separates from the gear portion 43 of the ink sheet take-up portion 4, the ink sheet take-up portion 4 is rectionally going to rotate in the direction (along arrow B) opposite to the rotational direction of the ink sheet take-up portion 4 for taking up the ink sheet 2q. At this time, the inner diameter of the spring portion 44b of the one-way spring 44 attached to the one-way spring mount portion 43c of the gear portion 43 of the ink sheet take-up portion 4 is so reduced that the outer peripheral surface of the one-way spring mount portion 43c of the gear portion 43 is clamped by the inner peripheral surface of the one-way spring 44. Thus, rotation of the gear portion 43 is suppressed, and that of the ink sheet take-up portion 4 is regulated. Therefore, rotation of the take-up bobbin 2e engaging with the ink sheet take-up portion 4 is also regulated in the direction (along arrow B) opposite to the direction for taking up the ink sheet 2q, whereby the ink sheet 2q can be prevented from loosening.

According to this embodiment, as hereinabove described, the sublimatic printer comprises the ink sheet take-up portion 4 for taking up the ink sheet 2q, the stepping motor 14 for driving the ink sheet take-up portion 4 and the rotating shaft 13a rotatably receiving the ink sheet take-up portion 4 while the ink sheet take-up portion 4 includes the gear portion 43 rotating in the prescribed direction (along arrow A in FIG. 2) by the driving force received from the stepping motor 14, the take-up reel 41 having the spring mount portion 41c for taking up the ink sheet 2q and the torque generation spring 42, interposed between the gear portion 43 and the take-up reel 41, having the gear engaging portion 42b engaging with the gear portion 43 and the coil portion 42a so mounted on the spring mount portion 41c of the take-up reel 41 as to come into close contact therewith the prescribed adhesion, whereby no slipping takes place between the torque generation spring 42 and the spring mount portion 41c of the take-up reel 41 but the rotational motion is so transmitted that the take-up reel 41 (ink sheet take-up portion 4) rotates in the prescribed direction (along arrow A in FIG. 4) when the load torque is less than the prescribed level. The load torque in the direction (along arrow T1 in FIG. 10) for increasing the inner diameter of the coil portion 42a is applied to the torque generation spring 42 when the take-up reel 41 takes up the ink sheet 2q while the torque generation spring 42 so idles with respect to the spring mount portion 41c of the take-up reel 41 as not to transmit the rotational motion of the gear portion 43 to the take-up reel 41 if load torque exceeding the prescribed level is applied to the take-up reel so that slipping automatically takes place between the torque generation spring 42 and the spring mount portion 41c of the take-up reel 41 when torque exceeding the prescribed level is applied to the take-up reel 41. Thus, the rotational motion can be prevented from transmission to the take-up reel 41 (ink sheet take-up portion 4) while the stepping motor 14 maintains the rotation in the transmittable direction (along arrow A in FIG. 2), without separately providing means for loosening the rotation caused by the driving force received from the stepping motor 14.

According to this embodiment, the gear portion 43 includes the spring engaging portion 43b engaging with the gear engaging portion 42b of the torque generation spring 42 while the gear engaging portion 42b of the torque generation spring 42 is so formed as to outwardly protrude in the radial direction of the coil portion 42a and the second end 42c of the torque generation spring 42 is arranged to be rotatable with respect to the spring mount portion 41c of the take-up reel 41 so that the gear engaging portion 42b of the torque generation spring 42 engaging with the spring engaging portion 43b of the gear portion 43 due to the rotation of the gear portion 43 receives force in the direction (along arrow T1 in FIG. 10) for increasing the inner diameter of the coil portion 42a of the torque generation spring 42 when load torque exceeding the prescribed level is applied to the take-up reel 41, whereby the adhesion between the torque generation spring 42 and the take-up reel 41 can be so reduced that the torque generation spring 42 idles with respect to the spring mount portion 41c of the take-up reel 41.

According to this embodiment, the inner diameter r (mm) of the coil portion 42a of the torque generation spring 42 in the state not mounted on the spring mount portion 41c is smaller than the radius R_{A} (mm) of the outer periphery of the spring mount portion 41c as shown in FIG. 10 while the adhesion of the torque generation spring 42 is controlled by controlling the difference between the radius R_{A} (mm) and the inner diameter r (mm) of the coil portion 42a, whereby prescribed torque for preventing the rotational motion of the gear portion 43 from transmission to the take-up reel 41 can be easily controlled.

According to this embodiment, the ink sheet take-up portion 4 further includes the one-way spring 44 for rotating the ink sheet take-up portion 4 only in the prescribed direction (along arrow A in FIG. 2) in addition to the torque generation spring 42, thereby preventing the rotational motion from transmission to the take-up reel 41 (ink sheet take-up portion 4) while allowing the stepping motor 14 to maintain the rotation in the transmittable direction (along arrow A in FIG. 2) with the torque generation spring 42, and the one-way spring 44 can prevent the take-up reel 41 from rotating in the opposite direction (along arrow B in FIG. 2).

According to this embodiment, the gear portion 43 has the one-way spring mount portion 43c while the one-way spring 44 is so mounted on the one-way spring mount portion 43c of the gear portion 43 that the hooked first end 44a thereof engages with the one-way spring engaging portion 13d so that the gear portion 43 is rotatable only in the prescribed direction (along arrow A in FIG. 2), whereby the take-up reel 41 interlocked with the gear portion 43 can be easily rendered rotatable only in the prescribed direction (along arrow A in FIG. 2). Consequently, the ink sheet 2q can be easily prevented from reverse winding.

According to this embodiment, the second end 42c of the torque generation spring 42 is so formed as to extend in the direction for separating from the spring mount portion 41c of the take-up reel 41. According to this structure, the second end 42c of the torque generation spring 42 can be prevented from coming into contact with the spring mount portion 41c, whereby the second end 42c can be inhibited from hindering rotation of the torque generation spring 42 by coming into contact with the spring mount portion 41c when the torque generation spring 42 rotates with respect to the spring portion 41c.

Although the present invention has been described and illustrated in detail, it is clearly understood that the same is by way of illustration and example only and is not to be taken by way of limitation, the spirit and scope of the present invention being limited only by the terms of the appended claims.

For example, while the aforementioned embodiment is applied to the sublimatic printer employed as an example of the image generating apparatus, the present invention is not restricted to this but is also applicable to an image generating apparatus other than the sublimatic printer, so far as the image generating apparatus comprises the ink sheet take-up portion 4.

While the gear engaging portion 42b outwardly protruding in the radial direction of the coil portion 42a is provided on the first end of the torque generation spring 42 for engaging with the spring engaging portion 43b of the gear portion 43 in the aforementioned embodiment, the present invention is not restricted to this but the gear engaging portion 42b may alternatively be rendered L-shaped, for reinforcing the engagement with the spring engaging portion 43b.

While the spring engaging portion 43b of the gear portion 43 is so notched as to engage with the gear engaging portion 42b of the torque generation spring 42 in the aforementioned embodiment, the present invention is not restricted to this but the spring engaging portion 43b of the gear portion 43 may alternatively be in the form of a hole, for example.

While the rib 43d is provided on the end of the one-way spring mount portion 43c of the gear portion 43 closer to the motor bracket 13 in the aforementioned embodiment, the present invention is not restricted to this but the rib 43d may alternatively be provided on a portion other than the aforementioned end, so far as this portion is closer to the motor bracket 13 (fixing member) than the torque generation spring 42.

What is claimed is:

1. An image generating apparatus comprising:
a take-up portion for taking up an ink sheet;
a driving source for driving said take-up portion; and
a rotating shaft rotatably receiving said take-up portion, wherein
said take-up portion includes a gear portion rotating in a prescribed direction by driving force received from said driving source, a take-up reel, having a first spring mount portion, for taking up said ink sheet and a torque generation spring member, interposed between said gear portion and said take-up reel, having a first end engaging with said gear portion and a coil portion so mounted on said first spring mount portion of said take-up reel as to come into close contact therewith prescribed adhesion, and
load torque in a direction for increasing the inner diameter of said coil portion is applied to said torque generation spring member when said take-up reel takes up said ink sheet, while said torque generation spring member so idles with respect to said first spring mount portion of said take-up reel as not to transmit the rotational motion of said gear portion to said take-up reel if load torque exceeding a prescribed level is applied to said take-up reel.

2. The image generating apparatus according to claim 1, wherein
said gear portion has an engaging portion engaging with said first end of said torque generation spring member, and
said first end of said torque generation spring member is so formed as to outwardly protrude in the radial direction of said coil portion, while a second end of said torque generation spring member is arranged to be rotatable with respect to said first spring mount portion of said take-up reel.

3. The image generating apparatus according to claim 2, wherein
said engaging portion of said gear portion includes a notch, and
said first end of said torque generation spring member is so formed as to engage with said notch of said gear portion.

4. The image generating apparatus according to claim 2, wherein
said second end of said torque generation spring member is so formed as to extend toward a direction for separating from said first spring mount portion of said take-up reel.

5. The image generating apparatus according to claim 1, wherein
the inner radius of said coil portion of said torque generation spring member in a state not mounted on said first spring mount portion is smaller than the radius of the outer periphery of said first spring mount portion while torque generated by said torque generation spring member is controlled by controlling the difference between the inner radius of said coil portion and the radius of the outer periphery of said first spring mount portion.

6. The image generating apparatus according to claim 1, wherein
said take-up portion further includes a one-way spring for rotating said take-up portion only in a single direction, in addition to said torque generation spring member.

7. The image generating apparatus according to claim 6, wherein
said gear portion has a second spring mount portion, and said one-way spring is mounted on said second spring mount portion of said gear portion so that a hooked first end thereof engages with a spring engaging portion.

8. The image generating apparatus according to claim 7, wherein
said gear portion has a one-way spring slippage regulating portion on an end of said second spring mount portion.

9. The image generating apparatus according to claim 8, wherein
said gear portion further has an engaging portion engaging with said first end of said torque generation spring member, and
said engaging portion, said second spring mount portion and said one-way spring slippage regulating portion are integrally formed on said gear portion.

10. The image generating apparatus according to claim 1, wherein
said take-up reel has a shaft portion rotatably inserted into an insertion portion of said gear portion, and
said take-up portion further includes a regulating member for inhibiting said shaft portion from moving in a direction for coming off said insertion portion.

11. An image generating apparatus comprising:
a take-up portion for taking up an ink sheet;
a rotating shaft rotatably receiving said take-up portion; and
a driving source for driving said take-up portion, wherein
said take-up portion includes a gear portion rotating in a prescribed direction by driving force received from said driving source, a take-up reel, having a first spring mount portion, for taking up said ink sheet, a torque generation spring member, interposed between said gear portion and said take-up reel, having a first end engaging with said gear portion and a coil portion so mounted on said first spring mount portion of said take-up reel as to come into close contact therewith prescribed adhesion and a one-way spring for rotating said take-up portion only in a single direction,
load torque in a direction for increasing the inner diameter of said coil portion is applied to said torque generation spring member when said take-up reel takes up said ink sheet, while said torque generation spring member so idles with respect to said first spring mount portion of said take-up reel as not to transmit the rotational motion of said gear portion to said take-up reel when load torque exceeding a prescribed level is applied to said take-up reel,
said gear portion has an engaging portion engaging with said first end of said torque generation spring member,
said first end of said torque generation spring member is so formed as to outwardly protrude in the radial direction of said coil portion, while a second end of said torque generation spring member is arranged to be rotatable with respect to said first spring mount portion of said take-up reel,
the inner radius of said coil portion of said torque generation spring member in a state not mounted on said first spring mount portion is smaller than the radius of the outer periphery of said first spring mount portion while torque generated by said torque generation spring member is controlled by controlling the difference between the inner radius of said coil portion and the radius of the outer periphery of said first spring mount portion, and
said gear portion has a second spring mount portion, and said one-way spring is mounted on said second spring mount portion of said gear portion so that a hooked first end thereof engages with a spring engaging portion.

12. The image generating apparatus according to claim 11, wherein
said engaging portion of said gear portion includes a notch, and
said first end of said torque generation spring member is so formed as to engage with said notch of said gear portion.

13. The image generating apparatus according to claim 11, wherein
said second end of said torque generation spring member is so formed as to extend toward a direction for separating from said first spring mount portion of said take-up reel.

14. The image generating apparatus according to claim 11, wherein
said gear portion has a one-way spring slippage regulating portion on an end of said second spring mount portion.

15. The image generating apparatus according to claim 14, wherein
said gear portion further has an engaging portion engaging with said first end of said torque generation spring member, and
said engaging portion, said second spring mount portion and said one-way spring slippage regulating portion are integrally formed on said gear portion.

16. The image generating apparatus according to claim 11, wherein
said take-up reel has a shaft portion rotatably inserted into an insertion portion of said gear portion, and
said take-up portion further includes a regulating member for inhibiting said shaft portion from moving in a direction for coming off said insertion portion.
